(19) United States
(12) Patent Application Publication
(10) Pub. No.: US 2026/0203744 A1
(43) Pub. Date: Jul. 16, 2026

(54) SYSTEMS AND METHODS FOR MULTI-LOOP TRANSACTION PROCESSING IN CLOSED-LOOP VIRTUAL NETWORKS

(71) Applicant: STATS LLC, Chicago, IL (US)

(72) Inventors: Marek PIOTROWICZ, Sunny Isles Beach, FL (US); James MCWILLIAMS, Las Vegas, NV (US); Nicholas PIOTROWICZ, Warszawa (PL); Michal FRANKIEWICZ, Warszawa (PL)

(73) Assignee: STATS LLC, Chicago, IL (US)

(21) Appl. No.: 19/444,449

(22) Filed: Jan. 9, 2026

Related U.S. Application Data
(60) Provisional application No. 63/743,970, filed on Jan. 10, 2025.

(51) Int. Cl. G06Q 20/34

(52) U.S. Cl. CPC G06Q 20/351

(57) ABSTRACT

A virtual system includes a memory for storing instructions and processors configured to execute operations. The operations include receiving a request from a user in a closed-loop system for an online transaction, wherein the transaction includes transferring a fund from a closed-loop account to a virtual account. The operations include generating the virtual account and a virtual identifier associated with the virtual account, wherein the virtual account is further associated with a primary identifier. The operations include blocking the primary identifier for the transaction to prevent the primary identifier's use for the fund transfer. The operations include processing the transaction by transferring the fund using the virtual identifier, wherein the expense using the virtual identifier is lower than using the primary identifier.

### CROSS-REFERENCE TO RELATED APPLICATIONS

This application claims priority to U.S. Application No. 63/743,970, titled Systems and Methods for Multi-Loop Processing, filed Jan. 10, 2025, which is hereby incorporated by reference in its entirety.

### FIELD OF INVENTION

The present disclosure relates to payment processing systems, and more particularly to systems and methods for multi-loop transaction processing using virtual identifiers in a closed-loop virtual network.

### BACKGROUND

For open-loop transactions, such as those processed through traditional credit and debit networks, payments typically follow standard network rails. When a user makes a payment using a credit or debit card, a transaction request is sent to a payment processor through the traditional open-loop networks. The processor then routes this request to the user's bank to validate fund availability and transaction legitimacy. Upon authorization, the traditional open-loop network manages the communication and settlement process, ensuring that funds are transferred from the user's bank to the merchant's bank. Merchants utilizing these conventional open-loop networks may incur associated fees, including transaction and interchange fees, and longer-than-desirable transaction times.

Unless otherwise indicated herein, the materials described in this section are not prior art to the claims in this application and are not admitted to be prior art, or suggestions of the prior art, by inclusion in this section.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a virtual system is provided. The virtual system includes a memory storing instructions and one or more processors operatively connected to the memory and configured to execute the instructions to perform operations. The operations include receiving a request from a user in a closed-loop system for an online transaction, wherein the online transaction includes a transfer of a fund from a closed-loop account in the closed-loop system to a virtual account in a virtual system. The operations further include generating the virtual account and a virtual identifier associated with the virtual account, wherein the virtual account is associated with a primary identifier. The operations further include blocking the primary identifier for the online transaction between the closed-loop system and the virtual system to prevent the use of the primary identifier for the transfer of the fund from the closed-loop account to the virtual account. The operations further include processing the online transaction by transferring the fund from the closed-loop account to the virtual account using the virtual identifier, wherein an expense for the transfer of the fund using the virtual identifier is lower than an expense for the transfer of the fund using the primary identifier.

According to other aspects of the present disclosure, the expense for the transfer of the fund using the virtual identifier may be zero.

According to other aspects of the present disclosure, the operations may further include receiving a second request from a second user in a second closed-loop system for a second online transaction, wherein the second online transaction includes a transfer of a second fund from a second closed-loop account in the second closed-loop system to the virtual account in the virtual system, and processing the second online transaction by transferring the second fund from the second closed-loop account to the virtual account using the virtual identifier.

According to other aspects of the present disclosure, the operations may further include receiving a third request from the user for a third online transaction, wherein the third online transaction includes a purchase of a service or product from an open-loop system using the fund in the virtual account.

According to other aspects of the present disclosure, the operations may further include processing the third online transaction by transferring at least a portion of the fund from the virtual account to an open-loop system using the primary identifier, wherein an expense for the transfer of at least a portion of the fund using the primary identifier is greater than the expense for the transfer of the fund using the virtual identifier, and wherein the virtual system receives at least a portion of the expense for the transfer.

According to other aspects of the present disclosure, the operations may further include increasing an amount of the fund based on a chosen outcome of a sporting event, wherein the chosen outcome is generated by a predictive model.

According to other aspects of the present disclosure, the virtual system may further include a second virtual account and a third virtual account, wherein the virtual account is associated with a first market entity, wherein the second virtual account is associated with a second market entity, and wherein the third virtual account is associated with a third market entity.

According to other aspects of the present disclosure, the virtual account, the second virtual account, and the third virtual account may be partitioned such that funds from the virtual account, the second virtual account, and the third virtual account cannot be directly transferred to each other.

According to other aspects of the present disclosure, the virtual identifier may be further associated with the second virtual account and the third virtual account, and the operations may further include receiving a second request from the user for a second online transaction, wherein the second online transaction includes a purchase of a service or product from an open-loop system using funds from the virtual account, the second virtual account, and the third virtual account, and processing the second online transaction by transferring at least a portion of the funds from the virtual account to an open-loop system using the primary identifier.

According to other aspects of the present disclosure, the virtual system may prioritize funds being transferred from the virtual account over the second virtual account and the third virtual account when purchasing the service or product from the open-loop system.

According to other aspects of the present disclosure, processing the second online transaction may further include transferring at least a second portion of the funds from the second virtual account and the third virtual account to the open-loop system using the primary identifier, and the virtual system may equally prioritize funds being transferred from the virtual account, the second virtual account, and the third virtual account when purchasing the service or product from the open-loop system.

According to other aspects of the present disclosure, the operations may further include receiving a second request from the user in the closed-loop system for a second online transaction, wherein the second online transaction includes a transfer of a second fund from the virtual account to the closed-loop account, determining that funds in the virtual account are less than the second fund, and blocking the second online transaction, wherein a total fund in the virtual account, the second virtual account, and the third virtual account is greater than the second fund.

According to other aspects of the present disclosure, the operations may further include receiving a third request from the user in the closed-loop system for a third online transaction, wherein the third online transaction includes a transfer of a third fund from the second virtual account to a second closed-loop account, determining that funds in the second virtual account are greater than the third fund, and permitting the third online transaction.

According to another aspect of the present disclosure, a method for transferring funds between a virtual system and a closed-loop system is provided. The method includes receiving a request from a user in a closed-loop system for an online transaction, wherein the online transaction includes a transfer of a fund from a closed-loop account in the closed-loop system to a virtual account in the virtual system. The method further includes generating the virtual account and a virtual identifier associated with the virtual account, wherein the virtual account is associated with a primary identifier. The method further includes blocking the primary identifier for an online transaction between the closed-loop system and the virtual system to prevent the use of the primary identifier for the transfer of the fund from the closed-loop account to the virtual account. The method further includes processing the online transaction by transferring the fund from the closed-loop account to the virtual account using the virtual identifier, wherein an expense for the transfer of the fund using the virtual identifier is lower than an expense for the transfer of the fund using the primary identifier.

According to other aspects of the present disclosure, the method may further include receiving a second request from a second user in a second closed-loop system for a second online transaction, wherein the second online transaction includes a transfer of a second fund from a second closed-loop account in the second closed-loop system to the virtual account in the virtual system, and processing the second online transaction by transferring the second fund from the second closed-loop account to the virtual account using the virtual identifier.

According to other aspects of the present disclosure, the method may further include a second virtual account and a third virtual account, wherein the virtual account is associated with a first market entity, wherein the second virtual account is associated with a second market entity, and wherein the third virtual account is associated with a third market entity.

According to other aspects of the present disclosure, the virtual account, the second virtual account, and the third virtual account may be partitioned such that funds from the virtual account, the second virtual account, and the third virtual account cannot be directly transferred to each other.

According to other aspects of the present disclosure, the virtual identifier may be further associated with the second virtual account and the third virtual account, and the operations may further include receiving a second request from the user for a second online transaction, wherein the second online transaction includes a purchase of a service or product from an open-loop system using funds from the virtual account, the second virtual account, and the third virtual account, and processing the second online transaction by transferring at least a portion of the funds from the virtual account to an open-loop system using the primary identifier.

According to another aspect of the present disclosure, a computer-readable storage medium is provided. The computer-readable storage medium includes instructions that, when executed by a processor, cause the processor to perform acts. The acts include receiving a request from a user in a closed-loop system for an online transaction, wherein the online transaction includes a transfer of a fund from a closed-loop account in the closed-loop system to a virtual account in the virtual system. The acts further include generating the virtual account and a virtual identifier associated with the virtual account, wherein the virtual account is associated with a primary identifier. The acts further include blocking the primary identifier for an online transaction between the closed-loop system and the virtual system to prevent the use of the primary identifier for the transfer of the fund from the closed-loop account to the virtual account. The acts further include processing the online transaction by transferring the fund from the closed-loop account to the virtual account using the virtual identifier, wherein an expense for the transfer of the fund using the virtual identifier is lower than an expense for the transfer of the fund using the primary identifier.

According to other aspects of the present disclosure, the expense for the transfer of the fund using the virtual identifier may be zero.

The foregoing general description of the illustrative embodiments and the following detailed description thereof are merely exemplary aspects of the teachings of this disclosure and are not restrictive.

### BRIEF DESCRIPTION OF FIGURES

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 illustrates an exemplary environment for a closed-loop virtual network with a virtual system, according to aspects of the present disclosure.

FIG. 2A illustrates a diagram showing transactions by a user of a closed-loop system, according to aspects of the present disclosure.

FIG. 2B illustrates a diagram showing the virtual system of FIG. 2A and associated virtual accounts.

FIG. 3 illustrates a flowchart for a process for multi-loop processing of online transactions, according to aspects of the present disclosure.

FIG. 4 illustrates a functional block diagram of a computer that may be configured to execute methods disclosed herein, according to aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for data extraction.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of order management, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Various aspects of the present disclosure relate to computer-implemented techniques for multi-loop processing of online transactions and, more particularly, to systems and methods for multi-loop processing by a virtual system in a closed-loop virtual network. The systems and methods described herein may provide an identification solution (e.g., virtual card, physical card, etc.) with a dual-identification setup that provides versatile payment options for users and merchants participating in the closed-loop virtual network.

In some aspects, the dual-identification setup may include a primary identifier and a virtual identifier. The primary identifier may be a standard card number (e.g., Visa™ number, MasterCard™ number, American Express™ number, etc.) used for open-loop transactions through traditional credit and debit networks. The virtual identifier may be a secondary account number used for closed-loop transactions within the closed-loop virtual network. The virtual identifier may be assigned during a card production or issuance phase and may be tailored to a product profile. In some cases, the virtual identifier may be generated at the closed-loop virtual network upon receiving a request from a user for an online transaction.

As previously mentioned, for open-loop transactions, such as those processed through traditional credit and debit networks, payments may follow standard network rails. When a user makes a payment using a credit or debit card, a transaction request may be sent to a payment processor through the traditional open-loop credit and debit networks. The processor may then route the request to a user bank to validate fund availability and transaction legitimacy. Upon authorization, the traditional open-loop credit and debit network may manage the communication and settlement process, ensuring that funds are transferred from the user's bank to a merchant's bank. Merchants utilizing these conventional open-loop networks may incur associated fees, including transaction fees and interchange fees.

In contrast, for closed-loop transactions within the closed-loop virtual network, fees may be reduced or eliminated. When payments are made between systems within the closed-loop virtual network, the transaction may be processed using the virtual identifier rather than the primary identifier. By using the virtual identifier for closed-loop transactions, the expense for the transfer of funds may be lower than the expense for the transfer of funds using the primary identifier. In some cases, the expense for the transfer of funds using the virtual identifier may be zero.

The closed-loop virtual network may include a virtual system and one or more closed-loop systems. The virtual system may be configured to process online transactions between the virtual system and the one or more closed-loop systems. For any systems within the closed-loop virtual network, any transaction between the closed-loop systems and the virtual system may be treated as a closed-loop transaction, and fees for the closed-loop transactions may be reduced compared to open-loop transactions. In some cases, the closed-loop transactions may incur a minimal percentage-based fee or a cents-based fee, or no fee at all. This closed-loop design may reduce transaction costs for closed-loop systems participating in the closed-loop virtual network.

The closed-loop systems may be market operators, such as systems in the sports market industry. In other cases, the closed-loop systems may be operators or systems in other industries, such as the travel industry, foreign exchange industry, or other suitable industries where privacy, security, and cost-effectiveness are considerations. The virtual system may also communicate with one or more open-loop systems, such as merchant systems and banks, for transactions outside the closed-loop virtual network.

As described above, the virtual system may be configured to generate virtual accounts and virtual identifiers associated with the virtual accounts. The virtual accounts and virtual identifiers may be associated with primary identifiers through application programming interface calls or other suitable mechanisms. The virtual system may block the primary identifiers for online transactions between the closed-loop systems and the virtual system to prevent the use of the primary identifiers for the transfer of funds between the closed-loop systems and the virtual system. By blocking the primary identifiers for closed-loop transactions, the virtual system may ensure that the reduced-fee closed-loop transaction processing is utilized for transfers within the closed-loop virtual network.

Accordingly, the dual-number setup may enable merchants and users to leverage traditional payment rails when needed while taking advantage of cost-effective closed-loop transactions within the closed-loop virtual network. With both open-loop and closed-loop capabilities, merchants may utilize the virtual system without changing existing setups, which may lead to faster payments and an enhanced user experience. The systems and methods described herein may provide cost savings and increased flexibility for systems in the closed-loop virtual network by reducing fees for closed-loop transactions compared to the interchange costs associated with open-loop payments.

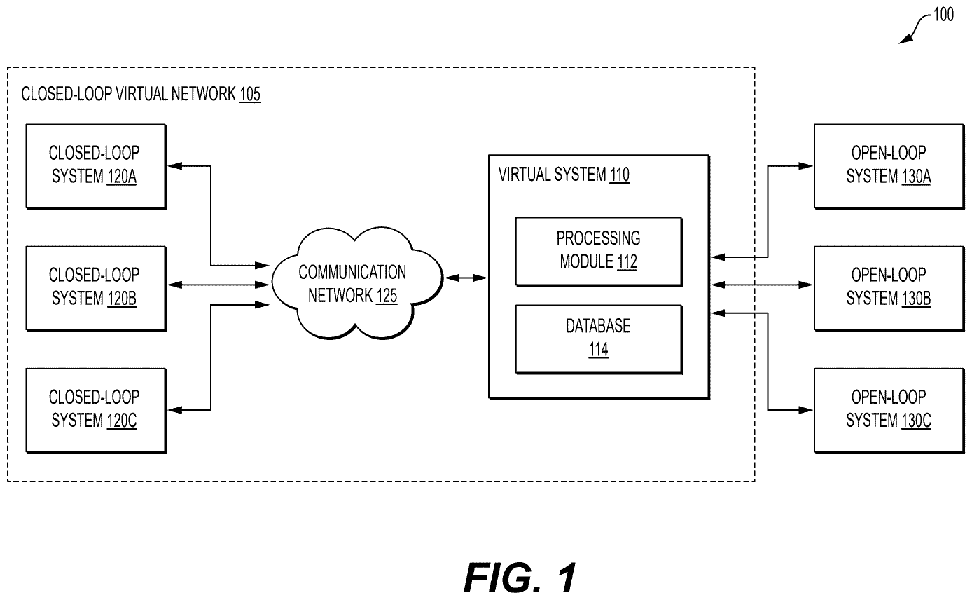

Referring to FIG. 1, an exemplary environment 100 for a closed-loop virtual network 105 with a virtual system 110 is illustrated. The environment 100 includes the closed-loop virtual network 105, which comprises the virtual system 110 and a plurality of closed-loop systems. The plurality of closed-loop systems may include a first closed-loop system 120A, a second closed-loop system 120B, and a third closed-loop system 120C. It is appreciated that the closed-loop virtual network 105 may include more closed-loop systems (e.g., four, five, six, etc.) or fewer closed-loop systems (e.g., one, two). The virtual system 110 may include a memory storing instructions and one or more processors operatively connected to the memory and configured to execute the instructions to perform operations. The virtual system 110 may further include a processing module 112 and a database 114.

With continued reference to FIG. 1, the processing module 112 may be configured to process one or more online transactions between the virtual system 110 and the closed-loop systems 120A, 120B, 120C. The processing module 112 may also be configured to process one or more online transactions between the virtual system 110 and one or more open-loop systems. The database 114 may store information needed to process the one or more online transactions. In some cases, the database 114 may include personally identifiable information about users of the virtual system 110 and the closed-loop systems 120A, 120B, 120C. The personally identifiable information may include a user's name, date of birth, social security number, email address, physical address, etc. The database 114 may further include information about virtual identifiers and primary identifiers associated with virtual accounts.

As further shown in FIG. 1, the environment 100 includes a first open-loop system 130A, a second open-loop system 130B, and a third open-loop system 130C. The open-loop systems 130A, 130B, 130C may be positioned outside the closed-loop virtual network 105. The first open-loop system 130A, the second open-loop system 130B, and the third open-loop system 130C may be merchant systems, banks, or other suitable commercial or non-commercial operators or systems in an open-loop network. The virtual system 110 may communicate with the open-loop systems 130A, 130B, 130C through connections (e.g., network connections, application programming interface (API) connections, secure socket layer (SSL) connections, transport layer security (TLS) connections, virtual private network (VPN) connections, or other suitable wired or wireless communication links) that extend beyond the closed-loop virtual network 105.

A communication network 125 may facilitate communication between the virtual system 110 and the closed-loop systems 120A, 120B, 120C. The communication network 125 may be a wide area network (WAN), a local area network (LAN), a personal area network (PAN), or another suitable network type. In some cases, the communication network 125 may include the Internet. The communication network 125 may be online, where online refers to connecting to or accessing source data from a location remote from other devices or networks coupled to the Internet. In some cases, online may refer to connecting or accessing an electronic network, whether wired or wireless, via a mobile communications network or device.

The first closed-loop system 120A, the second closed-loop system 120B, and the third closed-loop system 120C may be market operators in the sports market industry. In other cases, the closed-loop systems 120A, 120B, 120C may be operators or systems in other industries, such as the travel industry, foreign exchange industry, or other suitable industries. The closed-loop systems 120A, 120B, 120C may be associated with users, such as users viewing or interacting with a generated interactive user interface, or administrators of the closed-loop systems 120A, 120B, 120C.

Transactions between the virtual system 110 and the closed-loop systems 120A, 120B, 120C within the closed-loop virtual network 105 may be treated as closed-loop transactions. Fees for the closed-loop transactions may be reduced compared to fees for open-loop transactions. In some cases, the closed-loop transactions may incur a minimal percentage-based fee or a cents-based fee, or no fee at all. Transactions between the virtual system 110 and the open-loop systems 130A, 130B, 130C may follow standard open-loop transaction processing with associated fees, including interchange fees that go to the open-loop network. By processing transactions within the closed-loop virtual network 105 using virtual identifiers rather than primary identifiers, the virtual system 110 may reduce transaction costs for the closed-loop systems 120A, 120B, 120C participating in the closed-loop virtual network 105.

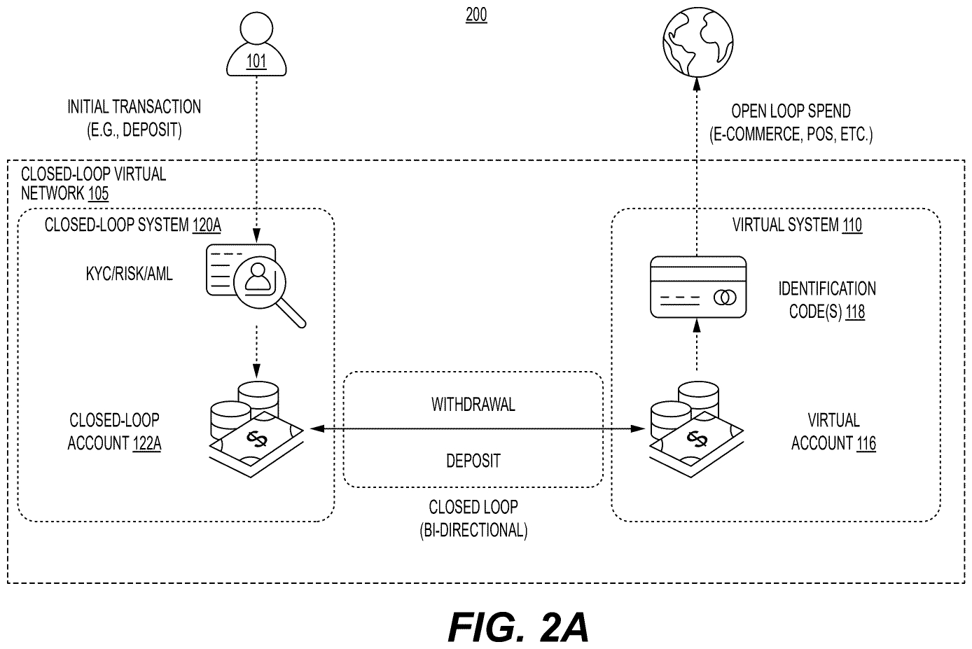

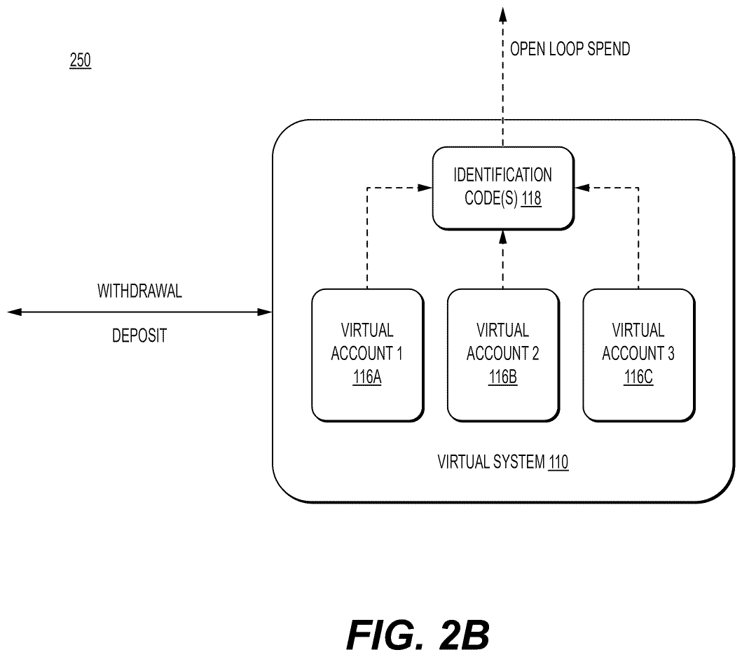

Referring to FIG. 2A, a diagram 200 illustrating transactions by a first user 101 of the first closed-loop system 120A is shown. The diagram 200 depicts the closed-loop virtual network 105 that includes the first closed-loop system 120A and the virtual system 110. The first user 101 may initiate an initial transaction, such as a deposit, with the first closed-loop system 120A. The initial transaction deposit may be processed between the first user's open-loop device or account, such as a credit card, debit card, bank account, or PayPal account, and a first closed-loop account 122A in the first closed-loop system 120A via an open-loop network.

The first closed-loop system 120A may perform verification tasks for the first user 101 prior to or during the initial deposit process. The first closed-loop system 120A may perform KYC (Know Your Customer) verification to confirm the identity of the first user 101. The first closed-loop system 120A may also perform AML (Anti-Money Laundering) compliance checks to ensure that the first user 101 and the transaction comply with applicable anti-money laundering regulations. The first closed-loop system 120A may further perform risk profile verification to assess potential risks that the first user 101 may pose to the first closed-loop system 120A. Upon completion of the KYC, AML, and risk profile verification, the first user 101 may deposit funds into the first closed-loop account 122A.

As further shown in FIG. 2A, the virtual system 110 includes virtual accounts 116 and a virtual identifier 118. The virtual system 110 may generate the virtual accounts 116 and the virtual identifier 118 associated with the virtual accounts 116. In some cases, the virtual accounts 116 may be generated upon receiving a request from the first user 101 for an online transaction to transfer funds from the first closed-loop account 122A to the virtual system 110. In other cases, the virtual accounts 116 may be generated at any other suitable time, such as when generating the first closed-loop account 122A for the first user 101. The virtual accounts 116 and the virtual identifier 118 may be associated with a primary identifier. The primary identifier may be a standard card number (e.g., Visa™ number, MasterCard™ number, American Express™ number, etc.) used for open-loop transactions through traditional credit and debit networks. The virtual accounts 116 and the virtual identifier 118 may be associated with the primary identifier through application programming interface (API) calls.

The virtual identifier 118 may be a secondary account number (SAN) used for closed-loop transactions within the closed-loop virtual network 105. The virtual identifier 118 may be assigned during a card production or issuance phase and may be tailored to a product profile associated with the first user 101 or the first closed-loop system 120A. In some cases, the virtual identifier 118 may be generated at the virtual system 110 upon receiving a request from the first user 101 for an online transaction.

The first user 101 may submit a request to the first closed-loop system 120A or the virtual system 110 for an online transaction. The online transaction may include a transfer of a fund from the first closed-loop account 122A in the first closed-loop system 120A to the virtual accounts 116 in the virtual system 110. Upon receiving the request from the first user 101, the virtual system 110 may block the primary identifier for the online transaction between the first closed-loop system 120A and the virtual system 110. By blocking the primary identifier, the virtual system 110 may prevent the use of the primary identifier for the transfer of the fund from the first closed-loop account 122A to the virtual accounts 116.

Instead, the virtual system 110 may process the online transaction by transferring the fund from the first closed-loop account 122A to the virtual accounts 116 using the virtual identifier 118. An expense for the transfer of the fund using the virtual identifier 118 may be lower than an expense for the transfer of the fund using the primary identifier. In some cases, the expense for the transfer of the fund using the virtual identifier 118 may be zero. By using the virtual identifier 118 for transactions within the closed-loop virtual network 105 rather than the primary identifier, the virtual system 110 may reduce or eliminate transaction fees that would otherwise be incurred through open-loop transaction processing.

As shown in FIG. 2A, the diagram 200 illustrates a bi-directional closed-loop connection between the first closed-loop account 122A and the virtual accounts 116. Withdrawal transactions may flow from the first closed-loop account 122A to the virtual accounts 116, and deposit transactions may flow from the virtual accounts 116 to the first closed-loop account 122A. The first user 101 may transfer funds between the first closed-loop account 122A and the virtual accounts 116 using the virtual identifier 118 within the closed-loop virtual network 105.

In some cases, the virtual system 110 may receive a second request from a second user in the second closed-loop system 120B for a second online transaction. The second online transaction may include a transfer of a second fund from a second closed-loop account in the second closed-loop system 120B to the virtual accounts 116 in the virtual system 110. The virtual system 110 may process the second online transaction by transferring the second fund from the second closed-loop account to the virtual accounts 116 using the virtual identifier 118. In this manner, the virtual accounts 116 may be used and shared with multiple closed-loop accounts in multiple closed-loop systems within the closed-loop virtual network 105.

Referring to FIG. 2B, a diagram 250 illustrating the virtual system 110 and virtual accounts 116 is shown. The diagram 250 depicts the internal structure of the virtual system 110, including the virtual accounts 116, such as a first virtual account 116A, a second virtual account 116B, and a third virtual account 116C. The virtual system 110 also includes the virtual identifier 118, which is connected to each of the first virtual account 116A, the second virtual account 116B, and the third virtual account 116C. The virtual identifier 118 may be associated with multiple virtual accounts within the virtual system 110, enabling the processing of transactions between closed-loop accounts and the virtual accounts using the virtual identifier 118 rather than primary identifiers associated with open-loop networks.

The first virtual account 116A may be associated with a first market entity, the second virtual account 116B may be associated with a second market entity, and the third virtual account 116C may be associated with a third market entity. The first market entity, the second market entity, and the third market entity may be different operators or systems within the closed-loop virtual network 105. In some cases, the market entities may be market operators in the sports market industry, the travel industry, the foreign exchange industry, or other suitable industries.

The first virtual account 116A, the second virtual account 116B, and the third virtual account 116C may be partitioned such that funds from the first virtual account 116A, the second virtual account 116B, and the third virtual account 116C cannot be directly transferred to each other. The partitioning of the virtual accounts may maintain separation between funds associated with different market entities while allowing a user to access funds from multiple virtual accounts through the virtual identifier 118 for transactions with open-loop systems.

The partitioning of the virtual accounts may be implemented through logical separation mechanisms within the database 114 of the virtual system 110. Each virtual account may be assigned a unique partition identifier that associates the virtual account with a corresponding market entity. The partition identifier may be stored as metadata within the database 114 and may be referenced during transaction processing to determine whether a requested fund transfer is permitted between virtual accounts.

In some aspects, the virtual system 110 may maintain a partition mapping table that associates each partition identifier with a market entity identifier. When the virtual system 110 generates a new virtual account, the virtual system 110 may assign the virtual account to a partition based on the market entity from which the initial fund transfer originated. For example, when the first user 101 transfers funds from the first closed-loop account 122A associated with the first closed-loop system 120A, the virtual system 110 may assign those funds to the first virtual account 116A, which is partitioned and associated with the first market entity corresponding to the first closed-loop system 120A.

The processing module 112 may enforce partition boundaries during closed-loop transaction processing. When the virtual system 110 receives a request to transfer funds between virtual accounts within the virtual system 110, the processing module 112 may query the partition identifiers associated with the source virtual account and the destination virtual account. If the partition identifiers indicate that the source virtual account and the destination virtual account are associated with different market entities, the processing module 112 may block the fund transfer and return an error response indicating that cross-partition transfers are not permitted within the closed-loop virtual network 105. The error response may include a blocked transaction.

In some cases, the partition enforcement may be implemented through access control rules stored in the database 114. Each partition may have associated access control rules that specify which operations are permitted for funds within that partition. The access control rules may permit deposits into the partition from closed-loop accounts associated with the corresponding market entity, permit withdrawals from the partition to closed-loop accounts associated with the corresponding market entity, and permit transfers from the partition to open-loop systems using the primary identifier. The access control rules may prohibit direct transfers between partitions associated with different market entities.

The separation of funds across partitions may provide accounting isolation for each market entity participating in the closed-loop virtual network 105. Funds deposited by users of the first closed-loop system 120A may remain segregated within the first virtual account 116A and may not be commingled with funds deposited by users of the second closed-loop system 120B in the second virtual account 116B or funds deposited by users of the third closed-loop system 120C in the third virtual account 116C. This segregation may facilitate reconciliation and reporting for each market entity and may support regulatory compliance requirements that mandate separation of customer funds across different business operations.

When a user initiates an open-loop transaction to purchase a service or product from an open-loop system, the partition restrictions may not apply. The virtual system 110 may permit the user to spend funds from any of the user's virtual accounts, regardless of the partition associations, when the transaction is processed through the open-loop network using the primary identifier. In some aspects, the virtual system 110 may aggregate available balances across the user's virtual accounts when determining whether sufficient funds exist to complete an open-loop purchase. The virtual system 110 may then debit the appropriate virtual accounts according to a prioritization scheme or user preference to fulfill the open-loop transaction amount

The virtual identifier 118 may have a digit format different from the format of the primary identifier. In some cases, the virtual identifier 118 may have less than 16 digits or more than 19 digits, while the primary identifier may have a digit format of 16-19 digits. In other cases, the virtual identifier 118 may be any suitable identifier including words or symbols for transactions in the closed-loop network, and the virtual identifier 118 may not be limited to numerical formats. Similarly, the primary identifier may be any suitable code including words or symbols for transactions in the open-loop network, and the primary identifier may not be limited to card numbers.

The virtual identifier 118 and the primary identifier may be tokenized, and the tokenized identifiers may be stored in the database 114 of the virtual system 110. Tokenization may provide an additional layer of security for the identifiers stored within the virtual system 110.

As previously mentioned, the virtual system 110 may block the primary identifier for online transactions between the closed-loop systems and the virtual system 110 by blocking a merchant category code (MCC) of the primary identifier. By blocking the MCC of the primary identifier, the virtual system 110 may prevent the use of the primary identifier for the transfer of funds between closed-loop accounts and virtual accounts within the closed-loop virtual network 105, and instead use the virtual identifier 118.

The processing module 112 may implement transaction routing logic to determine whether an incoming transaction request should be processed as a closed-loop transaction using the virtual identifier 118 or as an open-loop transaction using the primary identifier. When the virtual system 110 receives a transaction request, the processing module 112 may extract transaction parameters from the request, including a source account identifier, a destination account identifier, a transaction amount, and a merchant identifier or system identifier associated with the transaction destination.

The processing module 112 may query the database 114 to determine whether the destination of the transaction is a registered closed-loop system within the closed-loop virtual network 105. The database 114 may maintain a closed-loop system registry containing identifiers for each closed-loop system participating in the closed-loop virtual network 105. When the processing module 112 determines that the destination identifier matches an entry in the closed-loop system registry, the processing module 112 may flag the transaction for closed-loop processing using the virtual identifier 118.

In some aspects, the processing module 112 may evaluate a set of routing rules stored in the database 114 to determine the appropriate transaction pathway. The routing rules may include conditions based on transaction type, transaction amount, source account type, destination account type, and time of transaction. Each routing rule may specify a condition expression and an associated routing action. The processing module 112 may evaluate the condition expressions against the transaction parameters and may select the routing action associated with the first matching routing rule. The routing action may specify whether to route the transaction through the closed-loop pathway using the virtual identifier 118 or through the open-loop pathway using the primary identifier.

The processing module 112 may maintain a transaction routing table that maps destination identifiers to routing pathways. The transaction routing table may include entries associating each closed-loop system identifier with a closed-loop routing pathway and entries associating open-loop system identifiers or merchant category codes with an open-loop routing pathway. When processing a transaction request, the processing module 112 may perform a lookup in the transaction routing table using the destination identifier extracted from the transaction request. The result of the lookup may indicate the appropriate routing pathway for the transaction.

In some cases, the processing module 112 may implement a multi-stage routing determination process. In a first stage, the processing module 112 may determine whether the transaction involves a transfer between accounts within the closed-loop virtual network 105. In a second stage, the processing module 112 may validate that both the source account and the destination account are authorized for closed-loop transactions. In a third stage, the processing module 112 may verify that the virtual identifier 118 associated with the source account is active and has not expired. If all three stages result in affirmative determinations, the processing module 112 may route the transaction through the closed-loop pathway. If any stage results in a negative determination, the processing module 112 may route the transaction through the open-loop pathway or may reject the transaction and return an error response.

The processing module 112 may detect whether a transaction is within the closed-loop virtual network 105 by comparing the merchant identifier or system identifier associated with the transaction against a whitelist of closed-loop system identifiers stored in the database 114. The whitelist may be updated when new closed-loop systems join the closed-loop virtual network 105 or when existing closed-loop systems are removed from the closed-loop virtual network 105. In some aspects, the processing module 112 may also compare the merchant category code associated with the transaction against a list of merchant category codes designated for closed-loop processing.

The virtual system 110 may implement fallback routing logic for transactions that cannot be completed through the initially selected routing pathway. When the processing module 112 attempts to process a transaction through the closed-loop pathway and the transaction fails due to insufficient funds in the virtual account, network connectivity issues with the destination closed-loop system, or other processing errors, the processing module 112 may determine whether the transaction is eligible for fallback routing through the open-loop pathway. The fallback routing determination may be based on user preferences stored in the database 114, transaction type, and the nature of the processing error. In some cases, the processing module 112 may prompt the user to authorize fallback routing before processing the transaction through the open-loop pathway.

The processing module 112 may generate routing decision records for each processed transaction. The routing decision records may be stored in the database 114 and may include fields for the transaction identifier, the selected routing pathway, the routing rule or condition that determined the pathway selection, a timestamp, and the outcome of the transaction processing. The routing decision records may be used for transaction auditing, dispute resolution, and optimization of the routing rules.

In some aspects, the processing module 112 may implement real-time routing optimization based on transaction processing metrics. The processing module 112 may monitor transaction success rates, processing times, and error rates for each routing pathway. When the processing module 112 detects degraded performance on a particular routing pathway, the processing module 112 may temporarily adjust the routing rules to direct transactions to alternative pathways. The routing optimization may improve transaction success rates and reduce processing latency for users of the closed-loop virtual network 105.

The virtual system 110 may implement MCC blocking through a blocked category database maintained within the database 114. The blocked category database may store a list of merchant category codes that are designated for closed-loop transaction processing. When the virtual system 110 receives a transaction request that includes a merchant category code matching an entry in the blocked category database, the processing module 112 may prevent the transaction from being processed using the primary identifier and may instead route the transaction for processing using the virtual identifier 118.

In some aspects, the processing module 112 may perform MCC validation as part of transaction preprocessing. When a transaction request is received, the processing module 112 may extract the merchant category code from the transaction request data. The processing module 112 may then query the blocked category database to determine whether the extracted merchant category code is present in the list of blocked merchant category codes. The query may return a blocking status indicator that specifies whether the merchant category code is blocked for primary identifier transactions, permitted for primary identifier transactions, or subject to conditional blocking based on additional transaction parameters.

The blocked category database may include data fields for each blocked merchant category code entry, including the merchant category code value, a description of the merchant category, a blocking effective date, a blocking expiration date, and a blocking scope indicator. The blocking scope indicator may specify whether the blocking applies to all transactions associated with the merchant category code, only to transactions below a threshold amount, or only to transactions originating from specific closed-loop systems within the closed-loop virtual network 105.

The virtual system 110 may associate specific merchant category codes with closed-loop systems participating in the closed-loop virtual network 105. The database 114 may maintain a mapping table that associates each closed-loop system identifier with one or more merchant category codes used by that closed-loop system. When a transaction request includes a merchant category code that is mapped to a closed-loop system in the mapping table, the processing module 112 may automatically block the use of the primary identifier for that transaction and may process the transaction using the virtual identifier 118.

In some cases, the processing module 112 may implement hierarchical MCC blocking. Merchant category codes may be organized into category groups, and the blocked category database may include blocking rules at both the individual merchant category code level and the category group level. When evaluating a transaction, the processing module 112 may first check whether the specific merchant category code is blocked, and if no specific blocking rule exists, the processing module 112 may check whether the category group containing the merchant category code is blocked. This hierarchical approach may enable efficient management of blocking rules for large numbers of related merchant category codes.

The virtual system 110 may update the blocked category database in response to changes in the closed-loop virtual network 105 configuration. When a new closed-loop system joins the closed-loop virtual network 105, the virtual system 110 may add the merchant category codes associated with the new closed-loop system to the blocked category database. When a closed-loop system leaves the closed-loop virtual network 105, the virtual system 110 may remove the associated merchant category codes from the blocked category database or may update the blocking status to permit primary identifier transactions with that merchant category code.

The processing module 112 may generate MCC blocking audit records when a transaction is blocked from using the primary identifier. The MCC blocking audit records may be stored in the database 114 and may include fields for the transaction identifier, the blocked merchant category code, the blocking rule that triggered the block, a timestamp, and the alternative processing pathway selected for the transaction. The MCC blocking audit records may be used for compliance reporting, transaction dispute resolution, and analysis of blocking rule effectiveness.

In some aspects, the virtual system 110 may implement dynamic MCC blocking based on transaction patterns. The processing module 112 may monitor transaction volumes and patterns for each merchant category code. When the processing module 112 detects that a merchant category code is predominantly associated with transactions between closed-loop systems and the virtual system 110, the processing module 112 may recommend adding that merchant category code to the blocked category database. An administrator of the virtual system 110 may review the recommendation and may approve or reject the addition of the merchant category code to the blocked category database.

The expense for the transfer of funds using the virtual identifier 118 may be less than 40%, 50%, 60%, 70%, 80%, or 90% of the expense for the transfer of funds using the primary identifier. In some cases, the expense for the transfer of funds using the virtual identifier 118 may be zero. The reduced expense for closed-loop transactions may provide cost savings for users and market entities participating in the closed-loop virtual network 105.

The virtual system 110 may maintain a dual-fund architecture for each user, including a card balance and a cardholder funds repository. The card balance may represent funds that are available for immediate spending through the virtual identifier 118 or the primary identifier. The cardholder funds repository may represent funds that have been received from closed-loop systems but have not yet been allocated to the card balance. The separation of the card balance and the cardholder funds repository may enable the virtual system 110 to manage fund availability and settlement timing for different transaction types.

In some aspects, the database 114 may store separate ledger records for the card balance and the cardholder funds repository associated with each user. The card balance ledger record may include fields for a balance identifier, a user identifier, a current balance amount, a currency code, a last updated timestamp, and a balance status indicator. The cardholder funds ledger record may include fields for a funds identifier, a user identifier, a total funds amount, a pending funds amount, an available funds amount, a currency code, and a last updated timestamp. The pending funds amount may represent funds that have been initiated for transfer but have not yet completed settlement.

The virtual system 110 may implement fund allocation rules governing the movement of funds between the cardholder funds repository and the card balance. When the virtual system 110 receives funds from a closed-loop system on behalf of a user, the processing module 112 may initially credit the funds to the cardholder funds repository. The processing module 112 may then evaluate the fund allocation rules to determine whether and when to transfer funds from the cardholder funds repository to the card balance. The fund allocation rules may specify conditions based on settlement status, verification requirements, and user preferences.

In some cases, the virtual system 110 may permit transfers between card balances associated with the same user. When a user has multiple virtual accounts, each virtual account may have an associated card balance. The virtual system 110 may permit the user to transfer funds between the card balances of the user's own virtual accounts while restricting transfers between card balances of different users. The processing module 112 may validate card balance transfer requests by verifying that the source card balance and the destination card balance are both associated with the same user identifier in the database 114.

The processing module 112 may enforce restrictions on transfers between the cardholder funds repository and external accounts. Funds in the cardholder funds repository may be transferred to the card balance or withdrawn to a closed-loop account associated with the user, but may not be directly transferred to external open-loop accounts without first being allocated to the card balance. This restriction may enable the virtual system 110 to maintain accurate accounting of fund sources and to apply appropriate transaction processing rules based on the fund type.

The virtual system 110 may implement hold and release mechanisms for the card balance and the cardholder funds repository. When a user initiates a transaction that has not yet completed, the processing module 112 may place a hold on a portion of the card balance or the cardholder funds repository corresponding to the transaction amount. The hold may reduce the available balance while the transaction is pending. Upon completion of the transaction, the processing module 112 may release the hold and may debit the actual transaction amount from the appropriate fund repository. If the transaction fails or is cancelled, the processing module 112 may release the hold without debiting the fund repository.

In some aspects, the virtual system 110 may generate separate transaction histories for the card balance and the cardholder funds repository. The transaction history for the card balance may include records of spending transactions, card balance transfers, and allocations from the cardholder funds repository. The transaction history for the cardholder funds repository may include records of deposits from closed-loop systems, allocations to the card balance, and withdrawals to closed-loop accounts. The separate transaction histories may enable users and administrators to track fund movements and to reconcile balances across the dual-fund architecture.

The processing module 112 may calculate an aggregate available balance that combines the card balance and the available portion of the cardholder funds repository. When a user requests balance information, the virtual system 110 may return the aggregate available balance along with a breakdown showing the card balance amount and the cardholder funds amount separately. The aggregate available balance may be used to determine whether sufficient funds exist for open-loop transactions, while the individual fund amounts may be used to determine eligibility for specific transaction types within the closed-loop virtual network 105.

The virtual system 110 may receive a request from a user for an online transaction that includes a purchase of a service or product from an open-loop system using funds from the first virtual account 116A, the second virtual account 116B, and the third virtual account 116C. The virtual system 110 may process the online transaction by transferring at least a portion of the funds from the first virtual account 116A, the second virtual account 116B, and/or the third virtual account 116C to an open-loop system using the primary identifier. The virtual system 110 may receive a portion of the expense for the transfer of funds between the virtual accounts and the open-loop system using the primary identifier.

In some cases, the virtual system 110 may prioritize funds being transferred to the open-loop system from the first virtual account 116A over the second virtual account 116B and the third virtual account 116C when purchasing the service or product from the open-loop system. In other cases, processing the online transaction may further include transferring at least a second portion of the funds from the second virtual account 116B and the third virtual account 116C to the open-loop system using the primary identifier. Alternatively, the virtual system 110 may equally prioritize funds being transferred from the first virtual account 116A, the second virtual account 116B, and the third virtual account 116C when purchasing the service or product from the open-loop system.

The virtual system 110 may receive a request from a user in a closed-loop system for an online transaction that includes a transfer of a fund from the first virtual account 116A to a closed-loop account (e.g., closed-loop account 122A). The virtual system 110 may determine that funds in the first virtual account 116A are less than the fund requested for transfer. In response to determining that funds in the first virtual account 116A are less than the fund requested for transfer, the virtual system 110 may block the online transaction. The virtual system 110 may block the online transaction even when a total fund in the first virtual account 116A, the second virtual account 116B, and the third virtual account 116C is greater than the fund requested for transfer. The blocking of the online transaction may maintain the partitioning between the virtual accounts associated with different market entities.

The virtual system 110 may receive a request from the user in the closed-loop system for another online transaction that includes a transfer of a fund from the second virtual account 116B to the closed-loop account (e.g., closed-loop account 122A, a second closed-loop account, etc.). The virtual system 110 may determine that funds in the second virtual account 116B are greater than the fund requested for transfer. In response to determining that funds in the second virtual account 116B are greater than the fund requested for transfer, the virtual system 110 may permit the online transaction. The virtual system 110 may process the online transaction by transferring the fund from the second virtual account 116B to the second closed-loop account using the virtual identifier 118.

A first user and a second user transferring funds to the same virtual account may be the same person or entity. In other cases, the first user and the second user transferring funds to the same virtual account may be different persons or entities. The virtual system 110 may accommodate multiple users transferring funds to shared virtual accounts within the closed-loop virtual network 105.

Referring back to FIG. 2A, as previously discussed, the virtual system 110 may also be connected to an open-loop spend capability, enabling transactions with external systems such as e-commerce platforms and point of sale terminals. The virtual system 110 may receive a request from a user for an online transaction that includes a purchase of a service or product from an open-loop system using a fund in a virtual account. Upon receiving the request, the virtual system 110 may process the online transaction by transferring at least a portion of the fund from the virtual account to an open-loop account using a primary identifier associated with the virtual account. An expense for the transfer of at least a portion of the fund using the primary identifier may be greater than an expense for the transfer of the fund using a virtual identifier. The virtual system 110 may receive at least a portion of the expense for the transfer of at least a portion of the fund using the primary identifier. In this manner, the virtual system 110 may generate revenue from open-loop transactions while providing reduced-cost closed-loop transactions within the closed-loop virtual network 105.

The first closed-loop system 120A (or second closed-loop system 120B, third closed-loop system 120C, etc.) may be configured to generate an outcome for a sporting event. The first closed-loop system 120A may receive lineup information for a sporting event. The lineup information may include a first lineup having a first plurality of players for a first team and a second lineup having a second plurality of players for a second team. The first closed-loop system 120A may generate a predictive model using a deep neural network based on various information about the first team, the second team, and the sporting event. The first closed-loop system 120A may then generate, via the predictive model, a likely outcome of the sporting event.

Users of the first closed-loop system 120A may use funds in closed-loop accounts to increase or decrease the value of the funds based on sporting event outcomes. A user may predict an outcome of a sporting event, such as the outcome of a match prior to initiation of the match or during match play. When the user's prediction is correct, the value of the funds in the user's closed-loop account may be increased. When the user's prediction is incorrect, the value of the funds in the user's closed-loop account may be decreased. The virtual system 110 may perform operations including increasing an amount of a fund based on a chosen outcome of a sporting event, wherein the chosen outcome is generated by a predictive model. In this manner, the value of a user's virtual account may be determined based on an increase or decrease in value of a user account in a closed-loop system. In certain embodiments, increasing or decreasing an amount of a fund may involve a closed-loop transaction between the first closed-loop account 122A and an open-loop system or another closed-loop system associated with, for example, a market entity.

The virtual system 110 may perform the fund increase or decrease operation by receiving a notification or message from the first closed-loop system 120A indicating a change in the value of funds in the first closed-loop account 122A. The notification may include data identifying the user, the closed-loop account, and the amount of the increase or decrease. In some aspects, the virtual system 110 may maintain a synchronization mechanism with the first closed-loop system 120A to track changes in fund values in real-time or at periodic intervals.

In some cases, the virtual system 110 may receive an application programming interface call from the first closed-loop system 120A that specifies the fund adjustment amount and the direction of the adjustment. The virtual system 110 may validate the received information by checking the user's identity and the association between the closed-loop account and the corresponding virtual account. Upon validation, the virtual system 110 may update the balance of the virtual account to reflect the increase or decrease in fund value.

The fund increase operation may involve the virtual system 110 crediting the virtual account with an amount corresponding to the increase in value of the closed-loop account. The virtual system 110 may record the transaction in the database 114, including a timestamp, the transaction amount, and an identifier linking the transaction to the sporting event outcome. In some aspects, the virtual system 110 may generate a transaction record that associates the fund increase with the predictive model output and the user's prediction.

The fund decrease operation may involve the virtual system 110 debiting the virtual account by an amount corresponding to the decrease in value of the closed-loop account. The virtual system 110 may verify that sufficient funds exist in the virtual account before processing the debit. In some cases, if the virtual account has insufficient funds to cover the decrease, the virtual system 110 may flag the account or notify the first closed-loop system 120A of the discrepancy.

In some aspects, the virtual system 110 may process the fund increase or decrease as a closed-loop transaction using the virtual identifier 118, thereby avoiding the fees associated with open-loop transaction processing. The processing module 112 may execute the fund adjustment operation and update the database 114 with the new balance information. The virtual system 110 may also generate a confirmation message to the first closed-loop system 120A indicating that the fund adjustment has been completed.

In some aspects, the virtual system 110 may expose one or more application programming interfaces that enable closed-loop systems to integrate with the virtual system 110 for transaction processing. The application programming interfaces may include a widget integration interface, a user identification interface, a payment initiation interface, and a transaction status interface. The widget integration interface may enable closed-loop systems to embed a transaction widget within their platforms, allowing users to initiate fund transfers between closed-loop accounts and virtual accounts without navigating away from the closed-loop system's user interface.

The virtual system 110 may implement an OAuth grant mechanism for authenticating closed-loop systems that integrate with the virtual system 110. When a closed-loop system initiates integration with the virtual system 110, the closed-loop system may obtain an access token through the OAuth grant mechanism. The access token may permit the closed-loop system to perform authorized operations on behalf of users, including initiating withdrawals from closed-loop accounts to virtual accounts and initiating deposits from virtual accounts to closed-loop accounts. The OAuth grant mechanism may provide a standardized authentication protocol that allows closed-loop systems to securely authorize access to user accounts without exposing user credentials to the virtual system 110.

The virtual system 110 may receive user identification data from closed-loop systems through the user identification interface. The user identification data may include a unique user identifier assigned by the closed-loop system, which the virtual system 110 may associate with the user's virtual account and virtual identifier. In some cases, the unique user identifier may be a universally unique identifier (UUID) or other alphanumeric string that uniquely identifies the user within the closed-loop system. The virtual system 110 may maintain a mapping table in the database 114 that associates each unique user identifier received from a closed-loop system with the corresponding virtual account and virtual identifier in the virtual system 110.

The payment initiation interface may enable closed-loop systems to initiate fund transfers to and from users. When a closed-loop system initiates a payment to a user, the closed-loop system may transmit a payment initiation request to the virtual system 110. The payment initiation request may include data fields specifying the unique user identifier, the transaction amount, a transaction reference identifier, and a transaction type indicator. The transaction type indicator may specify whether the transaction is a withdrawal from the closed-loop account to the virtual account or a deposit from the virtual account to the closed-loop account. The virtual system 110 may validate the payment initiation request by verifying the access token, confirming the user's identity, and checking that sufficient funds exist for the requested transfer.

In some aspects, the virtual system 110 may generate the virtual identifier and associate the virtual identifier with the primary identifier through application programming interface calls to an external card issuance system. The external card issuance system may be operated by a payment network provider or a card issuing bank. The virtual system 110 may transmit a virtual identifier generation request to the external card issuance system, and the external card issuance system may return a generated virtual identifier along with association data linking the virtual identifier to the primary identifier. The association data may be stored in the database 114 and may include a token representing the primary identifier, an expiration date for the association, and status flags indicating whether the virtual identifier is active for closed-loop transactions.

The data structures used by the virtual system 110 may include a virtual account record, a virtual identifier record, and a transaction record. The virtual account record may include fields for a virtual account identifier, a user identifier, a balance amount, a currency code, a creation timestamp, and a status indicator. The virtual identifier record may include fields for the virtual identifier value, an associated virtual account identifier, an associated primary identifier token, an issuance date, an expiration date, and a status indicator. The transaction record may include fields for a transaction identifier, a source account identifier, a destination account identifier, a transaction amount, a transaction type, a timestamp, an identifier type indicator specifying whether the transaction used the virtual identifier or the primary identifier, and a transaction status.

In some cases, the virtual system 110 may maintain a closed-loop system registry in the database 114. The closed-loop system registry may include records for each closed-loop system integrated with the virtual system 110. Each record in the closed-loop system registry may include fields for a closed-loop system identifier, an OAuth client identifier, an OAuth client secret hash, authorized scopes specifying permitted operations, a webhook endpoint for receiving transaction notifications, and integration status flags. The processing module 112 may reference the closed-loop system registry when validating requests received from closed-loop systems and when determining whether a requested operation is authorized for the requesting closed-loop system.

The virtual system 110 may transmit transaction status notifications to closed-loop systems through webhook callbacks. When the virtual system 110 completes processing of a transaction, the processing module 112 may generate a transaction status message and transmit the transaction status message to the webhook endpoint registered by the closed-loop system. The transaction status message may include the transaction identifier, the transaction status, the processed amount, and a timestamp. The closed-loop system may use the transaction status message to update the balance of the corresponding closed-loop account and to notify the user of the completed transaction.

After the value of the fund in the first closed-loop system 120A is increased or decreased based on the result of the user's prediction, the user may submit a request to the first closed-loop system 120A or the virtual system 110 for a transfer of the increased or decreased funds, or at least a portion thereof, from the closed-loop account to a virtual account in the virtual system 110. The virtual system 110 may process the transfer using the virtual identifier rather than the primary identifier, thereby reducing or eliminating transaction fees that would otherwise be incurred through open-loop transaction processing.

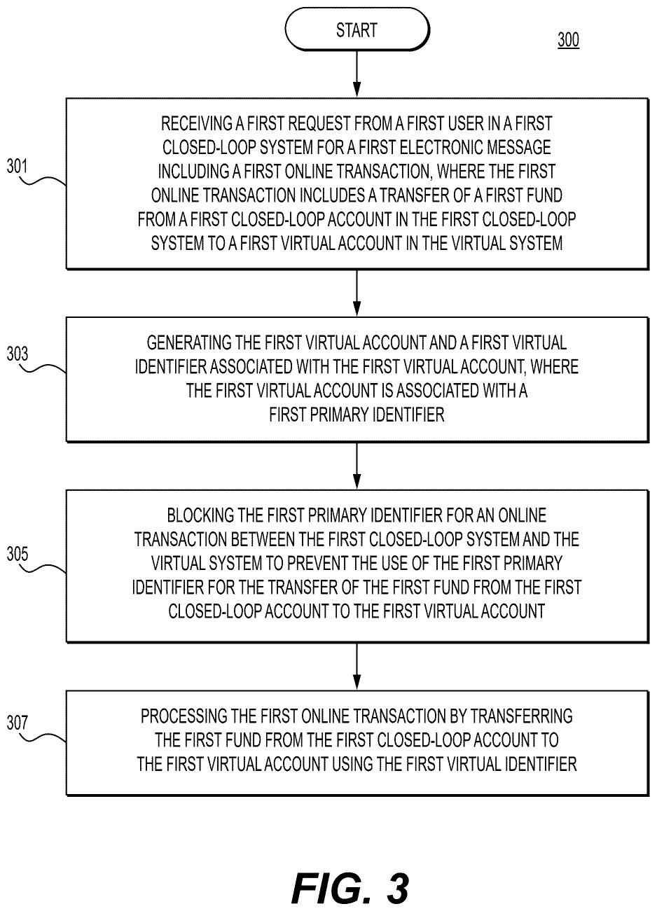

Referring to FIG. 3, a flowchart for a process 300 for multi-loop processing of online transactions is illustrated. The process 300 may be performed by the virtual system 110 and one or more components thereof. The virtual system 110 may provide means for accomplishing various parts of the process 300, as well as means for accomplishing embodiments of other processes described herein. Although the process 300 is illustrated and described as a sequence of steps, various embodiments of the process 300 may be performed in any order or combination, need not include all of the illustrated steps, and may include additional or other steps.

The process 300 begins at a first step 301. At the first step 301, the virtual system 110 may receive a request from a user in a closed-loop system for an electronic message including an online transaction. The online transaction may include a transfer of a fund from a closed-loop account in the closed-loop system to a virtual account in the virtual system 110. For example, when a user of a closed-loop system submits a request to the closed-loop system or the virtual system 110 for a transfer of funds from a closed-loop account in the closed-loop system to the virtual system 110, the virtual system 110 may receive the request. The request may be transmitted from the user to the closed-loop system, and the closed-loop system may then send the request to the virtual system 110. In other cases, the request from the user may be transmitted directly to the virtual system 110.

The process 300 then moves to a second step 303. At the second step 303, the virtual system 110 may generate the virtual account and a virtual identifier associated with the virtual account. The virtual account may be associated with a primary identifier. The primary identifier may be a card number of a user's payment vehicle, such as a credit card or debit card, for transactions in an open-loop network. The virtual identifier may be a virtual number for transactions in the closed-loop network. In some cases, the virtual identifier may have a digit format different from the digit format of the primary identifier. The virtual system 110 may generate the virtual account upon receiving the request from the user for the online transaction for the transfer of funds from the closed-loop account to the virtual system 110. Once the virtual account is generated in the virtual system 110, the user may be able to use the virtual account for additional online transactions without having to generate a new virtual account. In some cases, once the virtual account is generated, the virtual account may be associated with the user's closed-loop account from which the funds were transferred.

Following the second step 303, the process 300 proceeds to a third step 305. At the third step 305, the virtual system 110 may block the primary identifier for an online transaction between the closed-loop system and the virtual system 110. By blocking the primary identifier, the virtual system 110 may prevent the use of the primary identifier for the transfer of the fund from the closed-loop account to the virtual account. In some cases, the virtual system 110 may block the primary identifier by blocking a merchant category code (MCC) of the primary identifier. By blocking the primary identifier for transactions between the closed-loop system and the virtual system 110, the virtual system 110 may ensure that the reduced-fee closed-loop transaction processing is utilized for transfers within the closed-loop virtual network.

The process 300 then continues to a fourth step 307. At the fourth step 307, the virtual system 110 may process the online transaction by transferring the fund from the closed-loop account to the virtual account using the virtual identifier. An expense for the transfer of the fund using the virtual identifier may be lower than an expense for the transfer of the fund using the primary identifier. In some cases, the expense for the transfer of the fund using the virtual identifier may be zero. In other cases, the expense for the transfer of the fund using the virtual identifier may be less than approximately 40%, 50%, 60%, 70%, 80%, 90%, or the like, of the expense for the transfer of the fund using the primary identifier. By processing the online transaction using the virtual identifier rather than the primary identifier, the virtual system 110 may reduce transaction costs for closed-loop systems participating in the closed-loop virtual network.

The processing module 112 may implement real-time transaction processing for fund transfers within the closed-loop virtual network 105. When the virtual system 110 receives a transaction request, the processing module 112 may initiate a synchronous processing sequence that validates the transaction, executes the fund transfer, and returns a transaction result within a defined time threshold. The time threshold for real-time transaction processing may be less than five seconds, less than three seconds, or less than one second, depending on the transaction type and the network conditions between the virtual system 110 and the closed-loop systems 120A, 120B, 120C.

In some aspects, the processing module 112 may generate transaction messages in a standardized message format for communication with closed-loop systems. The transaction message format may include a message header and a message body. The message header may include fields for a message identifier, a message type indicator, a timestamp, a source system identifier, a destination system identifier, and a message version number. The message body may include fields for the transaction identifier, the transaction type, the source account identifier, the destination account identifier, the transaction amount, the currency code, the virtual identifier 118, and additional transaction metadata.

The virtual system 110 may implement message serialization and deserialization for transaction processing. When the processing module 112 generates a transaction message, the processing module 112 may serialize the message into a transmission format such as JavaScript Object Notation (JSON), Extensible Markup Language (XML), or a binary protocol format. When the virtual system 110 receives a transaction message from a closed-loop system, the processing module 112 may deserialize the message from the transmission format into an internal data structure for processing. The serialization and deserialization may enable interoperability between the virtual system 110 and closed-loop systems that use different internal data representations.

The processing module 112 may implement transaction timeout handling for real-time transaction processing. When the processing module 112 initiates a transaction, the processing module 112 may start a timeout timer with a configurable timeout duration. If the transaction processing completes before the timeout timer expires, the processing module 112 may cancel the timeout timer and return the transaction result. If the timeout timer expires before the transaction processing completes, the processing module 112 may abort the transaction, release any held funds, and return a timeout error response to the requesting system.

In some cases, the processing module 112 may implement transaction retry logic for failed transactions. When a transaction fails due to a transient error such as a network connectivity issue or a temporary unavailability of a closed-loop system, the processing module 112 may automatically retry the transaction. The retry logic may include a configurable maximum retry count and a retry delay interval. The processing module 112 may increment a retry counter with each retry attempt and may cease retrying when the retry counter reaches the maximum retry count. The retry delay interval may increase with each successive retry attempt to implement exponential backoff.

The virtual system 110 may implement idempotency controls for transaction processing. Each transaction request may include a unique idempotency key generated by the requesting system. The processing module 112 may store the idempotency key in the database 114 along with the transaction result. When the processing module 112 receives a transaction request with an idempotency key that matches a previously processed transaction, the processing module 112 may return the stored transaction result without reprocessing the transaction. The idempotency controls may prevent duplicate fund transfers when transaction requests are retried due to network issues or timeout errors.

The processing module 112 may implement transaction settlement for completed transactions within the closed-loop virtual network 105. Settlement may occur in real-time or in batches depending on the transaction volume and the settlement agreements between the virtual system 110 and the closed-loop systems. For real-time settlement, the processing module 112 may update the balances of the source account and the destination account immediately upon transaction completion. For batch settlement, the processing module 112 may record the transaction in a settlement queue and may process the settlement queue at defined intervals such as hourly, daily, or at end-of-day.

In some aspects, the virtual system 110 may maintain transaction processing queues to manage high transaction volumes. When the processing module 112 receives transaction requests at a rate exceeding the processing capacity, the processing module 112 may place incoming transaction requests in a processing queue. The processing module 112 may retrieve transaction requests from the processing queue in order and may process each transaction request sequentially or in parallel depending on the available processing resources. The processing queue may implement priority levels such that high-priority transactions are processed before lower-priority transactions.

The virtual system 110 may generate transaction confirmation messages upon successful completion of a transaction. The transaction confirmation message may be transmitted to the closed-loop system that initiated the transaction and may also be transmitted to the user associated with the transaction. The transaction confirmation message may include the transaction identifier, the transaction status, the processed amount, the updated account balance, and a timestamp. In some cases, the virtual system 110 may transmit the transaction confirmation message through multiple channels including application programming interface responses, webhook callbacks, email notifications, or push notifications to mobile devices.

The process 300 may provide cost savings and increased flexibility for systems in the closed-loop virtual network. Reduced fees for closed-loop transactions may minimize interchange costs associated with open-loop payments. The dual-identification setup including the primary identifier and the virtual identifier may enable merchants to leverage traditional payment rails when needed while taking advantage of cost-effective closed-loop transactions within the closed-loop virtual network. With both open-loop and closed-loop capabilities, merchants may utilize the virtual system 110 without changing existing setups, which may lead to faster payments and an enhanced user experience.

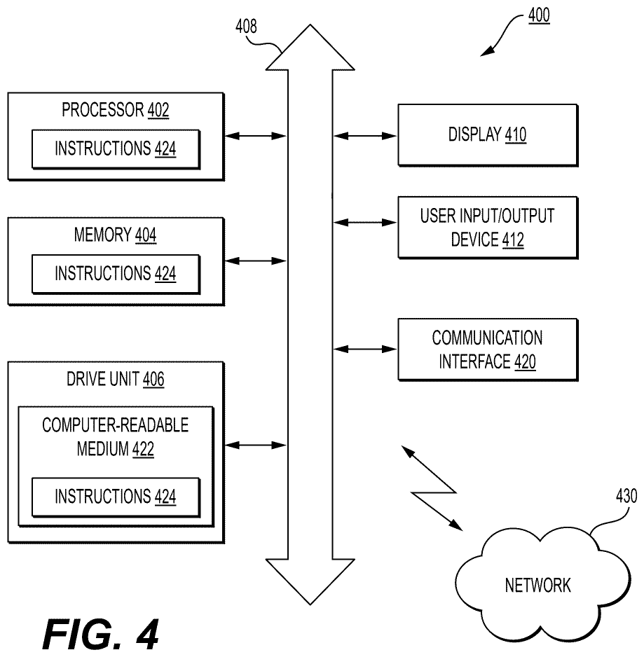

Referring to FIG. 4, a simplified functional block diagram of a computer 400 that may be configured as a device for executing the methods disclosed herein is illustrated. The computer 400 may be configured as a system according to aspects of the present disclosure. The virtual system 110 may be implemented using the computer 400 or components thereof. The computer 400 may be applicable to any environment, such as a desktop or laptop computer, an automobile entertainment system, or a home entertainment system.

The computer 400 may include a data communication interface 420 for packet data communication. The data communication interface 420 may enable the computer 400 to communicate with a network 430. The network 430 may correspond to the communication network 125 described with reference to FIG. 1. The computer 400 may receive programming and data via network communications through the network 430 rather than from local storage.

The computer 400 may also include a central processing unit (CPU) 402, in the form of one or more processors, for executing program instructions. The central processing unit 402 may execute instructions to perform the operations described herein, including the operations of the process 300 described with reference to FIG. 3.

With continued reference to FIG. 4, the computer 400 may include an internal communication bus 408. The internal communication bus 408 may facilitate communication between the central processing unit 402 and other components of the computer 400. The computer 400 may further include a storage unit 406 that may store data on a computer readable medium 422. The storage unit 406 may be a read-only memory (ROM), a hard disk drive (HDD), a solid-state drive (SSD), or other suitable storage device.

The computer 400 may also have a memory 404 storing instructions 424 for executing techniques presented herein. The memory 404 may be a random-access memory (RAM) or other suitable memory device. The instructions 424 may be stored temporarily or permanently within other modules of the computer 400, such as the central processing unit 402 or the computer readable medium 422. The instructions 424 may include instructions for performing the systems and methods described with reference to FIG. 1, FIG. 2A, FIG. 2B, and FIG. 3.

As further shown in FIG. 4, the computer 400 may also include input and output ports 412 and a display 410 to connect with input and output devices. The input and output devices may include keyboards, mice, touchscreens, monitors, displays, or other suitable devices. The internal communication bus 408 may facilitate communication between the central processing unit 402, the memory 404, the storage unit 406, the display 410, the output ports 412, and the data communication interface 420.

The various system functions may be implemented in a distributed fashion on a number of similar platforms to distribute the processing load. In some cases, the systems may be implemented by appropriate programming of one computer hardware platform. The software may be communicated through the Internet or various other telecommunication networks, enabling loading of the software from one computer or processor into another. The physical elements that carry software waves, such as wired or wireless links and optical links, may be considered as media bearing the software.

The closed-loop virtual network 105 and components thereof may be part of a widget that can be integrated by operators to initiate payments to and from users. The widget may be an embeddable component that operators can install within their platforms to facilitate fund transfers between closed-loop accounts and virtual accounts. The widget may provide a user interface for users to initiate withdrawal transactions from closed-loop accounts to virtual accounts, as well as deposit transactions from virtual accounts to closed-loop accounts.

The closed-loop virtual network 105 may include configurable widget templates that operators can select and customize for their specific use cases. The configurable widget templates may include a prepaid card withdrawal template and an OAuth template. The prepaid card withdrawal template may enable users to withdraw funds from a virtual account and have a prepaid card generated for the user. The OAuth template may enable operators to authenticate users through an OAuth grant mechanism when integrating with the virtual system.

The closed-loop virtual network 105 may use OAuth grant for authentication when operators integrate with the solution. OAuth grant may provide a standardized authentication protocol that allows operators to securely authorize access to user accounts without exposing user credentials. When an operator integrates with the virtual system using OAuth, the operator may obtain an access token that permits the operator to perform authorized operations on behalf of the user.

The closed-loop virtual network 105 may generate a prepaid card for users to withdraw funds from the virtual account. The prepaid card may be a payment instrument that allows users to spend funds from the virtual account at merchants that accept the prepaid card. The closed-loop virtual network 105 may support both virtual and physical prepaid card models. A virtual prepaid card may be a digital representation of a prepaid card that can be used for online transactions and e-commerce purchases. A physical prepaid card may be a tangible card that can be used at point of sale terminals and automated teller machines.

The multi-loop transaction processing system may provide technical improvements over conventional payment processing systems. The technical improvements may include reduced transaction costs, increased payment flexibility, and streamlined integration for participating systems.

The multi-loop transaction processing system may provide cost savings through reduced interchange fees for closed-loop transactions. In conventional open-loop payment processing, merchants may incur transaction fees and interchange fees when processing payments through traditional credit and debit networks. The interchange fees may range from approximately 2% to 3.5% of the transaction value, plus additional per-transaction fees in cents. By processing transactions within the closed-loop virtual network using virtual identifiers rather than primary identifiers, the multi-loop transaction processing system may reduce or eliminate these interchange fees. In some cases, the expense for closed-loop transactions may be zero. In other cases, the expense for closed-loop transactions may be a minimal percentage-based fee or a cents-based fee that is substantially lower than the interchange fees associated with open-loop transactions. The reduced transaction costs may provide financial benefits for operators and users participating in the closed-loop virtual network.

The dual-identification setup may provide increased flexibility for payment processing. By supporting both open-loop and closed-loop transaction capabilities, the multi-loop transaction processing system may enable operators and users to leverage traditional payment rails when needed while taking advantage of cost-effective closed-loop transactions within the closed-loop virtual network. The dual-number setup may provide versatile payment options that accommodate different transaction scenarios and merchant preferences.

The multi-loop transaction processing system may provide seamless integration for operators without requiring changes to existing setups. Operators may integrate with the multi-loop transaction processing system through embeddable widgets and application programming interfaces. The integration may not require operators to modify their existing payment infrastructure or replace their current payment processing systems. Operators may continue to use their existing systems for open-loop transactions while adding closed-loop transaction capabilities through the multi-loop transaction processing system. The seamless integration may reduce implementation time and costs for operators adopting the multi-loop transaction processing system.

The multi-loop transaction processing system may have practical applications across various industries. In the market industry, the multi-loop transaction processing system may enable market operators to process deposits and withdrawals between user accounts and virtual accounts with reduced transaction fees. Market operators may use the closed-loop transaction capabilities to transfer funds between market accounts and virtual accounts without incurring the interchange fees associated with open-loop transactions. Users may deposit funds into market accounts and withdraw winnings to virtual accounts using the virtual identifier, and users may then use the primary identifier to spend funds from the virtual accounts at external merchants.

In the travel industry, the multi-loop transaction processing system may enable travel operators to process payments for travel services with reduced transaction costs. Travel operators participating in the closed-loop virtual network may accept payments from users through closed-loop transactions, reducing the interchange fees that would otherwise be incurred through open-loop payment processing. Users may transfer funds from travel-related accounts to virtual accounts and use the funds for travel purchases within the closed-loop virtual network or at external merchants through open-loop transactions.

In the foreign exchange industry, the multi-loop transaction processing system may enable foreign exchange operators to process currency transactions with reduced fees. Foreign exchange operators may use the closed-loop transaction capabilities to transfer funds between user accounts and virtual accounts without incurring the interchange fees associated with traditional payment networks. The reduced transaction costs may be beneficial in the foreign exchange industry where transaction volumes may be high and fee reductions may result in substantial cost savings.

The multi-loop transaction processing system may lead to faster payments compared to conventional payment processing. By processing closed-loop transactions within the closed-loop virtual network rather than through traditional open-loop payment networks, the multi-loop transaction processing system may reduce the number of intermediaries involved in transaction processing. The reduced number of intermediaries may result in faster transaction settlement times. Users may receive funds in their virtual accounts more quickly when funds are transferred through closed-loop transactions compared to open-loop transactions that may involve multiple payment network intermediaries.

A number of implementations have been described. Nevertheless, it will be understood that various modifications may be made without departing from the spirit and scope of the disclosure. Accordingly, other implementations are within the scope of the following claims.

What is claimed is:

1. A virtual system comprising:
a memory storing instructions; and
one or more processors operatively connected to the memory and configured to execute the instructions to perform operations including:
receiving a request from a user in a closed-loop system for an online transaction, wherein the online transaction includes a transfer of a fund from a closed-loop account in the closed-loop system to a virtual account in a virtual system;
generating the virtual account and a virtual identifier associated with the virtual account, wherein the virtual account is associated with a primary identifier;
blocking the primary identifier for the online transaction between the closed-loop system and the virtual system to prevent use of the primary identifier for the transfer of the fund from the closed-loop account to the virtual account; and
processing the online transaction by transferring the fund from the closed-loop account to the virtual account using the virtual identifier,
wherein an expense for the transfer of the fund using the virtual identifier is lower than an expense for transfer of the fund using the primary identifier.

2. The virtual system of claim 1, wherein the expense for the transfer of the fund using the virtual identifier is zero.

3. The virtual system of claim 1, wherein the operations further comprise:
receiving a second request from a second user in a second closed-loop system for a second online transaction, wherein the second online transaction includes a transfer of a second fund from a second closed-loop account in the second closed-loop system to the virtual account in the virtual system; and
processing the second online transaction by transferring the second fund from the second closed-loop account to the virtual account using the virtual identifier.

4. The virtual system of claim 3, wherein the operations further comprise:
receiving a third request from the user for a third online transaction, wherein the third online transaction includes a purchase of a service or product from an open-loop system using the fund in the virtual account.

5. The virtual system of claim 4, wherein the operations further comprise:
processing the third online transaction by transferring at least a portion of the fund from the virtual account to the open-loop system using the primary identifier,
wherein an expense for the transfer of at least a portion of the fund using the primary identifier is greater than the expense for the transfer of the fund using the virtual identifier, and wherein the virtual system receives at least a portion of the expense for the transfer.

6. The virtual system of claim 1, where the operations further comprise increasing an amount of the fund based on a chosen outcome of a sporting event, wherein the chosen outcome is generated by a predictive model.

7. The virtual system of claim 1, wherein the virtual system further includes a second virtual account and a third virtual account, wherein the virtual account is associated with a first market entity, wherein the second virtual account is associated with a second market entity, and wherein the third virtual account is associated with a third market entity.

8. The virtual system of claim 7, wherein the virtual account, the second virtual account, and the third virtual account are partitioned such that funds from the virtual account, the second virtual account, and the third virtual account cannot be directly transferred to each other.

9. The virtual system of claim 7, wherein the virtual identifier is further associated with the second virtual account and the third virtual account, and wherein the operations further comprise:
receiving a second request from the user for a second online transaction, wherein the second online transaction includes a purchase of a service or product from an open-loop system using funds from the virtual account, the second virtual account, and the third virtual account; and
processing the second online transaction by transferring at least a portion of the funds from the virtual account to the open-loop system using the primary identifier.

10. The virtual system of claim 9, wherein the virtual system prioritizes funds being transferred from the virtual account over the second virtual account and the third virtual account when purchasing the service or product from the open-loop system.

11. The virtual system of claim 9, wherein processing the second online transaction further includes transferring at least a second portion of the funds from the second virtual account and the third virtual account to the open-loop system using the primary identifier, and wherein the virtual system equally prioritizes funds being transferred from the virtual account, the second virtual account, and the third virtual account when purchasing the service or product from the open-loop system.

12. The virtual system of claim 7, wherein the operations further comprise:
receiving a second request from the user in the closed-loop system for a second online transaction, wherein the second online transaction includes a transfer of a second fund from the virtual account to the closed-loop account;
determining that funds in the virtual account are less than the second fund; and
blocking the second online transaction, wherein a total fund in the virtual account, the second virtual account, and the third virtual account is greater than the second fund.

13. The virtual system of claim 12, wherein the operations further comprise:
receiving a third request from the user in the closed-loop system for a third online transaction, wherein the third online transaction includes a transfer of a third fund from the second virtual account to a second closed-loop account;
determining that funds in the second virtual account are greater than the third fund; and
permitting the third online transaction.

14. A method for transferring funds between a virtual system and a closed-loop system, the method comprising:
receiving a request from a user in the closed-loop system for an online transaction, wherein the online transaction includes a transfer of a fund from a closed-loop account in the closed-loop system to a virtual account in the virtual system;
generating the virtual account and a virtual identifier associated with the virtual account, wherein the virtual account is associated with a primary identifier;
blocking the primary identifier for an online transaction between the closed-loop system and the virtual system to prevent use of the primary identifier for the transfer of the fund from the closed-loop account to the virtual account; and
processing the online transaction by transferring the fund from the closed-loop account to the virtual account using the virtual identifier,
wherein an expense for the transfer of the fund using the virtual identifier is lower than an expense for the transfer of the fund using the primary identifier.

15. The method of claim 14, further comprising:
receiving a second request from a second user in a second closed-loop system for a second online transaction, wherein the second online transaction includes a transfer of a second fund from a second closed-loop account in the second closed-loop system to the virtual account in the virtual system; and
processing the second online transaction by transferring the second fund from the second closed-loop account to the virtual account using the virtual identifier.

16. The method of claim 14, wherein the virtual system further includes a second virtual account and a third virtual account, wherein the virtual account is associated with a first market entity, wherein the second virtual account is associated with a second market entity, and wherein the third virtual account is associated with a third market entity.

17. The method of claim 16, wherein the virtual account, the second virtual account, and the third virtual account are partitioned such that funds from the virtual account, the second virtual account, and the third virtual account cannot be directly transferred to each other.

18. The method of claim 16, wherein the virtual identifier is further associated with the second virtual account and the third virtual account, further comprising:
receiving a second request from the user for a second online transaction, wherein the second online transaction includes a purchase of a service or product from an open-loop system using funds from the virtual account, the second virtual account, and the third virtual account; and
processing the second online transaction by transferring at least a portion of the funds from the virtual account to an open-loop system using the primary identifier.

19. A computer-readable storage medium comprising instructions that, when executed by a processor, cause the processor to perform acts comprising:
receiving a request from a user in a closed-loop system for an online transaction, wherein the online transaction includes a transfer of a fund from a closed-loop account in the closed-loop system to a virtual account in a virtual system;
generating the virtual account and a virtual identifier associated with the virtual account, wherein the virtual account is associated with a primary identifier;
blocking the primary identifier for an online transaction between the closed-loop system and the virtual system to prevent the use of the primary identifier for the transfer of the fund from the closed-loop account to the virtual account; and
processing the online transaction by transferring the fund from the closed-loop account to the virtual account using the virtual identifier,
wherein an expense for the transfer of the fund using the virtual identifier is lower than an expense for the transfer of the fund using the primary identifier.

20. The computer-readable storage medium of claim 19, wherein the expense for the transfer of the fund using the virtual identifier is zero.
